(19) United States
(12) Patent Application Publication
(10) Pub. No.: US 2010/0012372 A1
(43) Pub. Date: Jan. 21, 2010

(54) Wire Beam

(76) Inventors: Renatus Marius de Zwart, Eindhoven (NL); Roland Anthony Tacken, Geldrop (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/517,829

(22) PCT Filed: Dec. 4, 2007
(86) PCT No.: PCT/NL2007/050618

§ 371 Date: Aug. 3, 2009

(30) Foreign Application Priority Data
Dec. 7, 2006 (EP) 06077193.8

(51) Int. Cl. H01B 7/00; B29C 45/00; C25D 5/34

(52) U.S. Cl. 174/71 R; 264/104; 205/205

(57) ABSTRACT

Manufacturing a wire beam (1), comprising a support member (2) and a number of conductors (3). In order to incorporate the conductors on or in the support member the wire beam is manufactured by means of a so-called moulded interconnect device (MID) manufacture process. At least part of the conductors may be shaped, during the MID manufacturing process, as conductors which are conductively interconnected at their ends. The interconnected conductors then may be used as a common electrode during an electrodeposition process in which the conductors are galvanized electrically to provide them with an additional conductive layer. The interconnected ends are removed after completion of the electrodeposition process.

### FIELD OF THE INVENTION

The invention concerns a wire beam configuration, e.g. to be used in a vehicle.

### BACKGROUND

Wire beams in vehicles (cars, trucks, aeroplanes etc.) often include a carrier or support body, on which or in which a plurality of isolated copper wires are mounted. Wire beams are rather large and laborious products. The assembly times are rather long. The reliability and serviceability of complex wire beams may be problematic in some cases.

### SUMMARY

One object is to provide an improved wire beam (or wire tree) manufacture method, having a shorter processing time needed to manufacture the wire beam. An additional and/or alternative object is to provide for a more reliable wire beam.

A method of manufacturing a wire beam, comprising a support member and a number of conductors, is provided that comprises incorporating the conductors on or in the support member by means of a moulded interconnect device (MID) manufacture method.

Moreover, a wire beam is provided, comprising a support member and a number of conductors, wherein the conductors and the support member form a moulded interconnect device (MID) wherein the conductors are incorporated on or in the support member.

### BRIEF DESCRIPTION OF THE DRAWING

Exemplary embodiments will be described using the following figures.

FIG. 1 shows a view of an example of a wire beam;

FIG. 2 shows a cross-sectional view of an exemplary wire beam.

FIG. 3 shows an end of a wire beam with connectors.

### DETAILED DESCRIPTION OF EXEMPLARY EMBODIMENTS

A Moulded Interconnect Device (MID) is defined as an injection moulded substrate which incorporates a conductive circuit pattern, and integrates mechanical and electrical functions. MIDs are usually three dimensional (i.e. not planar) and a variety of techniques may be used to apply the conductors and components. The conductive circuit pattern may be incorporated on or in the injection moulded substrate, i.e. the conductors may be attached along their length to the surface of the injection moulded substrate or conductors may be attached to completely surrounding injection moulded substrate material along their length.

The MID technology has made significant advances in recent years, particularly the development of high-temperature resins and using rapid prototyping techniques to generate pre-production examples, but requirements for multilayers, high component densities and plated-through holes will continue to be met by conventional planar printed circuit board technology. A review can be found at http://www.primefaraday.org.uk/technology-watch/technology-reviews/moulded-interconnect-devices.pdf This review has been published by the Prime Faraday Partnership, under the title “Moulded Interconnect Devices” in February 2002 (ISBN 1-84402-021-5).

By using MID techniques, the intended conducting tracks may be preprocessed (e.g. by laser surface treating) and subsequently (electroless) metallized. The conductive tracks applied to the synthetic carrier (support member) have a flat shape. No assembly is needed anymore. Until now MID is mainly used for small products and for low power applications. Using MID technology for large products and/or high power applications in e.g. automotive, aviation etc. is not known from the prior art.

The electric current which might be conducted by MID tracks is presumed to be rather restricted. However, experiments, done by applicant, indicate that the limits are much higher than generally presumed until now.

Advantages of using MID based wire beams included reduction of the assembly time, reliability, weight reduction, cost reduction and space reduction. Application areas include all areas in which wiring beams (trees) are used in combination with high(er) power, e.g. automotive, aviation, aerospace.

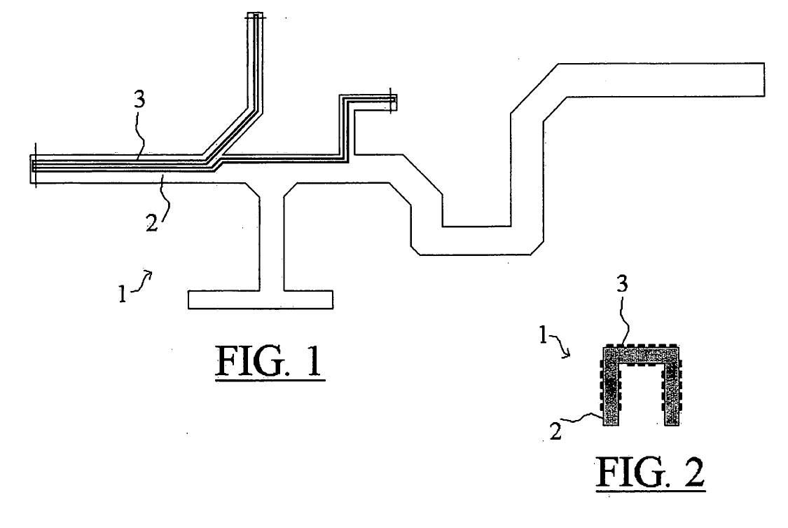

In general a wire beam is any rigid structure that comprises a plurality of conductors running between inputs and outputs. Wire beams may be used in vehicles such as cars and aircraft, where their rigidity should be sufficient to be self-supporting between attachments to the vehicle (i.e. not to sag in an appreciable way when not under tension). The wire beam 1 shown in FIG. 1, comprises a support member 2 and a number of conductors 3. The wire beam has the shape of a moulded interconnect device (MID): the conductors 3 are incorporated at the outer or inner (see FIG. 2) surface of the support member 2. That is, the conductive material is attached to the outer or inner surface over substantially the entire length of the conductive material.

The wire beam 1 is made by the moulded interconnect device (MID) manufacture method which is known as such, so it may be redundant to discuss several MID techniques. However, for the sake of completeness, below some items of the MID process will be reviewed, referencing to http://www.primefaraday.org.uk/technology-watch/technology-reviews/moulded-interconnect-devices.pdf (in print under ISBN 1-84402-021-5)

Essentially, MIDs can be produced in a variety of ways to suit the application at hand. Established methods of manufacture include Single-shot injection moulding, Two-shot moulding and Film Techniques.

In the case of single-shot injection moulding, the moulding process is followed by a series of metallizing steps that are very similar to those employed for conventional printed circuitry. One of the key techniques utilised in the manufacture of MIDs with fine circuit traces is photoimaging. To describe this process in simple terms, the MID substrate is chemically treated to promote adhesion between the plastic and metal that will be plated on it. Typically, a thin layer of electroless copper is deposited onto the substrate's surface to make it conductive, followed by the application of an electrophoretic resist resin. Exposure to ultraviolet light through a photomask—a film that carries the artwork of the required circuit traces—causes the resin to harden where the circuit pattern is required; the unhardened resin is then removed, revealing the underlying electroless copper which is then stripped off via chemical means. In the next stage the hardened resist is also chemically removed to reveal the circuit traces underneath. This leaves the plastic moulding with only the desired circuit pattern.

The typical process stages for single-shot injection moulding of MIDs are:
Injection mould the substrate: The part is injection moulded in a platable grade of thermoplastic. Alternatively any other type of material may be used that can be injected in liquid form and subsequently solidified. In addition to thermoplastic material this includes thermosetting material, sludges from which ceramic materials can be baked, photosetting material etc.
Electroless plate: The surface is chemically prepared to accept electroless plating and a thin layer of electroless copper is deposited on the entire surface.
Coat resist: A photosensitive polymer resist is applied over the entire part including through-holes (if any) and three-dimensional features.
Expose to UV and develop: The moulding is exposed to UV light through a conforming phototool such that the resist hardens. The unexposed resist is then chemically removed in the developing stage.
Electroplate metals: Copper and metals such as tin/lead or nickel/gold are deposited.
Strip resist and etch background copper: The resist is removed from unplated areas and the background copper is etched.

There is a variation of this process which utilises fully additive plating techniques. In this case the entire plastic substrate is copper plated to a specified final thickness before resist is applied. The photomask is designed so that this resist is exposed and hardened only where the circuit tracks are required. After unhardened resist is chemically removed, the entire thickness of copper which has been uncovered is removed, again leaving the plastic substrate with only the desired circuit pattern. However, the copper tracks are still covered with hardened resist, which is then chemically removed so that the circuitry can be finished as required.

Two-Shot Moulding uses two separate moulding cycles and usually different polymers to form the component. It requires the construction of different mould cavities for each shot. Catalysed resin versions of this process use a polymer that contains a small quantity of plating catalyst. The part is designed so that imaging is undertaken during moulding by leaving this catalysed resin exposed on the surface of the final part only where the circuit traces are required. This is accomplished by creating two moulds. The first shot is moulded and then inserted into the second mould in which the second resin system forms the final three-dimensional features of the component. Depending on part design, either the first or second shot resin may be the one containing a plating catalyst. Chemical treatment is undertaken to promote adhesion between the plastic and the metal plated onto it so that when the moulding is put through an electroless copper plating cycle, only resin containing the catalyst plates and thus creates the circuit pattern. Other electroless metal overlays can be applied if desired, and it is not unusual to employ rotary moulds or robotic handling for two-shot moulding processes.

The process stages therefore are:
Injection mould first shot: A first shot, which usually contains non-catalysed resin, is injection moulded in one cavity in a mould. This produces a first-stage moulding having identifiable areas for placement or incorporation of further moulding material for additional processing.
Injection mould second shot: The first-stage moulding is inserted into a second cavity where a second shot, generally of platable catalysed resin, is introduced into the mould. This typically produces a moulding with exposed, platable, catalysed resin on its surface, the patterns of which define the required circuit tracks.
Promote adhesion: As part of the plating process, the moulding undergoes a chemical treatment to enhance the ability of catalysed resin to accept plating.
Plate the part: The moulding is copper plated to a specified thickness. Metallic or organic finishes may then be applied.

A variation of this technique is to use resins which do not contain a plating catalyst. In this case the first shot is moulded and chemically treated with a catalyst before moulding the second shot. Copper plating is then undertaken and only the resin that has been chemically treated plates to form circuits.

So, two-shot moulding can enable very complex three-dimensional circuitry to be produced, limited only by an ability to mould the component since there are no additional imaging steps involved. Plated-through holes can be accommodated, but because circuit design changes usually require mould modifications it is more difficult and expensive to incorporate changes on parts within this process. Line and width spacing is limited by the moulding process, and it is generally difficult to achieve spacings as low as other PCB techniques; a typical value is 0.25 mm. It is the least labour-intensive process and generally the easiest to automate for high-volume production. However, tooling costs are high, which means that it is more suited to high-volume production requirements, typically associated with the telecommunications and automotive industries.

Film techniques have in common the fact that the conducting material starts out as a separate flexible film and is subsequently attached to an injection-moulded plastic substrate. The conductors are usually formed from copper laminate, foil or silver conductive inks on a carrier. Typical film processes are the Capture Process, the Transfer Process and Hot Stamping.

The capture process utilises preformed circuits on a flexible carrier, which are inserted into an injection mould. The circuits are formed either by printing conductive inks, or by etching copper-clad films. Circuits on a flexible carrier are die-cut to shape and can be thermoformed into three dimensions before insertion into the mould. Polymeric resin is injected behind the carrier, thus forcing it against the outer surfaces of the mould when the cycle is complete, the carrier with circuit becomes an integral part of a rigid injection moulded item; plating may be used to increase circuit thickness or provide a different metal topcoat, and circuits on the carrier can be single or double-sided (connected by vias in the carrier).

The transfer process is a variation of the capture process in that the flexible film is peeled away rather than remaining with the moulded part. In this case, the top of the circuits are flush with the moulded surface which can have benefits for applications requiring sliding contacts.

Hot stamping is another technique that utilises flexible copper foil coated with an adhesive. A special embossing die is built incorporating a heated block. The substrate is injection moulded prior to applying the circuit. Foil is pressed onto the polymer surface using this heated die and is simultaneously cut into the shape of the embossing die, thus forming a circuit. It is a relatively simple technique but the plastic surface where the circuit is to be embossed must be comparatively flat or have a smooth, uniform contour so that the embossing die can precisely contact the surface. In general, these film processes are more easily applied to relatively flat surfaces but are capable of providing moderately complex three-dimensional circuits using special techniques. Since the circuitry is on a separate carrier it is easy to modify circuit design provided this does not necessitate mould modifications. Track line and width spacing in the region of 0.025 mm is no real problem, but is it difficult to provide plated through holes.

MID processes like 2-component injection moulding, hot stamping etc., reviewed in the preceding, are already used to manufacture 3D-MIDs. At present the predominantly used processes are two-shot injection moulding, hot embossing, insert moulding and laser structuring (additive and subtractive). The associated high initial manufacturing costs, however, considerably limit the efficiency of these methods for small production runs and design modifications. Prototyping shortly before series production is almost impossible. Moreover, increasing miniaturisation of the circuits on MID components leads to a considerable rise in tooling-up time and expense. A rather novel process, introduced by LPKF (www.lpkf.com), the socalled MID-LDS method (LDS standing for Laser Direct Structuring) is a flexible and economic alternative. According to the LDS process the three-dimensional circuit carrier is injection moulded from a modified polymer material. The modification allows laser activation of circuit tracks on the surface of the circuit carrier. The activated areas become metalized in a chemical metalisation bath in order to build conductive tracks. Advantages of the LDS method are:
More flexibility because the laser directly transfers the artwork from the computer to the injection-moulded component, so no additional tools or masks are required. Structuring takes place solely on the basis of the existing CAD data.
Tooling costs significantly reduced because laser-structurable MIDs can be made using 1-component injection moulding.
Lasers are ideal for the production of ultra-fine structures.
High cost efficiency for fine structures and small to medium production runs in particular.
Highly pro-environment because no caustic or etching chemicals are used.

The conductors of wire beam may each run between opposite ends of the wire beam, with their conductive material attached to the outer or inner surface of the support member 2. Alternatively, some or all of the conductors may have input and/or output connections part of the way between the opposite ends of the wire beam.

According to a preferred and more elaborated embodiment of the invention a number of tracks may—in first instance—be short-circuited at one or both of the ends of the wire beams, facilitating to include all or a plurality of conductive tracks together in an electrical circuit which is used to perform electrodeposition (process for applying a galvanic layer using electric current) upon the tracks, viz. to provide them with an additional conductive layer which is thick and robust enough to conduct large currents which may be used in the relevant, e.g. automotive, applications. Those short-circuited ends of the conductive tracks may be cut or punched off after the electrodeposition process has been completed.

When some or all of the conductors have input and/or output connections part of the way between the opposite ends of the wire beam, the conductors may extend to one or both ends for this purpose. In this case, part of these conductors, between the input and/or output and an end of the wire beam may be left unused in normal use, being provided only for electrodeposition. Alternatively, such parts may be removed after deposition, or they may not be deposited at all, using the connections to the conductors part of the way along the wire beam to make electrical contact during electrodeposition, or using a different type of deposition process.

Instead of electrodeposition other methods of forming conductors may be used. For example conductive and non-conductive plastics may be used in different steps of a multi step moulding process respectively. In this case the wire beam and the conductors may be formed with a series of different moulds, placing the product formed with one or more preceding mould each time in the next and injecting mouldable material. By injecting conductive and non-conductive plastics in different moulds respectively the wire beam and the conductors may be formed.

Preferably, connectors are provided on the rigid support member to facilitate connection to the conductors on the wire beam. When the conductors lie on the surface of the wire beam, the end of the wire beam itself may form such a connector. A mating connector part may be realized in the form of a cap or ring shaped to be placed over the end of the wire beam, with conductors facing the conductors on the wire beam, for example a ring with an interior cross-section that matches the exterior cross-section of the wire beam (see the cross-section of FIG. 2).

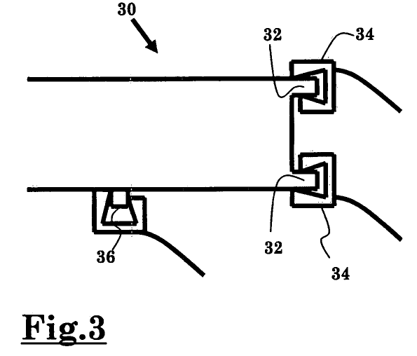

FIG. 3 shows an end of a wire beam 30 in an alternative embodiment where the wire beam 30 has been moulded with protruding ledges 32 at its ends onto which the conductors (not shown) extend. In this case mating conductors 34 may be used that fit over ledges 32. When a conductor is provided in the wire beam a ledge may extend from the end of the wire beam at the place where the conductor emerges from the wire beam. Such connectors may be provided at the opposite ends and/or part of the way between the opposite ends, e.g. midway or between one tenth and nine tenth of the way, if needed in normal use. Such an optional ledge 36 part of the way is shown in FIG. 3 by way of example.

As an alternative to deposition conductors in the MID devices may be realized by insert moulding, in which case the conductors are provided in the mould before the material to form the support member is injected in the mould. As another alternative to form conductors in the wire beam, the wire beam may be moulded with conduits through the wire beam, one or more conductive layers being deposited subsequently on the walls of the conduits. Conduits may be formed using a mould with a shape that defines the conduits, by blow moulding to blow out material from the conduits, by moulding multiple parts of the wire beam separately and subsequently joining these parts, or by multi-step moulding. Conduits in the mould can also be formed by moulding multiple parts of the wire beam separately, depositing one or more conductive layers on the parts and subsequently joining these parts, or by multi-step moulding with intermediate deposition of one or more conductive layers.

To protect the conductive tracks (e.g. to be used in trucks etc.) against corrosion etc., the conductive tracks may be covered by a protective layer, e.g. made of a polymer or an anti-corrosive conductor.

1. A method of manufacturing a wire beam, comprising a support member and a number of conductors, the method comprising: incorporating the conductors on or in the support member by means of a moulded interconnect device (MID) manufacturing process.

2. The method according to claim 1, comprising:
shaping at least part of the conductors, during the MID manufacturing process, as conductors which are conductively interconnected at their ends;
using the interconnected conductors as a common electrode during a consecutive electrodeposition process in which the conductors are galvanized electrically to provide them with an additional conductive layer; and
removing the interconnected ends of the conductors after completion of the electrodeposition process.

3. A wire beam, comprising a support member and a plurality of conductors, the wire beam being a moulded interconnect device (MID) wherein the plurality of conductors are incorporated on or in of the support member.

4. The wire beam according to claim 3, wherein at least part of the conductors comprise a base conductive layer attached to the support member and an additional conductive layer on the base conductive layer.

5. The wire beam according to claim 3, wherein at least part of the conductors comprise an anti-corrosive layer.

6. The wire beam according to claim 4, wherein at least part of the conductors comprise an anti-corrosive layer.
